(19) United States
(12) Patent Application Publication
(10) Pub. No.: US 2023/0074844 A1
(43) Pub. Date: Mar. 9, 2023

(54) INFORMATION PROCESSING DEVICE, DELIVERY SYSTEM, INFORMATION PROCESSING METHOD, AND STORAGE MEDIUM

(71) Applicant: TOYOTA JIDOSHA KABUSHIKI KAISHA, Toyota-shi (JP)

(72) Inventors: Kazumi SERIZAWA, Toyota-shi (JP); Hidekazu SASAKI, Yokohama-shi (JP); Daisuke SATO, Toyota-shi (JP); Shunsuke MOGI, Cyohu-shi (JP)

(73) Assignee: TOYOTA JIDOSHA KABUSHIKI KAISHA, Toyota-shi (JP)

(21) Appl. No.: 17/889,790

(22) Filed: Aug. 17, 2022

(30) Foreign Application Priority Data
Aug. 27, 2021 (JP) 2021-139200

(51) Int. Cl. G06Q 10/08; G05D 1/00

(52) U.S. Cl. CPC G06Q 10/0833; G05D 1/0088; G05D 2201/0216

(57) ABSTRACT

An information processing device includes at least one processor, wherein the at least one processor is configured to: receive authentication request information requesting an authentication operation between a moving body for making deliveries, which is capable of autonomous movement, and a user terminal that communicates with the moving body; acquire status information relating to a delivery status of the moving body; and transmit operation information relating to the authentication operation to the user terminal, based on the status information.

### CROSS-REFERENCE TO RELATED APPLICATION

This application is based on and claims priority under 35 USC 119 from Japanese Patent Application No. 2021-139200 filed on Aug. 27, 2021, the disclosure of which is incorporated by reference herein.

### BACKGROUND

### Technical Field

The present disclosure relates to an information processing device, a delivery system, an information processing method, and a storage medium.

### Related Art

Japanese Patent Application Laid-Open (JP-A) No. 2021-033581 discloses a home delivery system in which a delivery company receives a delivery instruction from a user, searches for a route to a delivery destination of a package for which a delivery instruction has been received, and based on the route, a home delivery robot performs package delivery.

However, as in the technology described in JP-A No. 2021-033581, in a case in which a package is delivered via a home delivery robot, operation may be difficult in a case in which a user does not understand an operation method of the home delivery robot.

### SUMMARY

In consideration of the above facts, an object of the present disclosure is to facilitate an authentication operation performed on a moving body in a case in which delivery of a package is performed via a moving body for deliveries.

An information processing device according to a first aspect of the present disclosure includes: a receiving section that receives authentication request information requesting an authentication operation between a moving body for making deliveries, which is capable of autonomous movement, and a user terminal that communicates with the moving body; an acquisition section that acquires status information relating to a delivery status of the moving body; and a transmitting section that transmits operation information relating to the authentication operation to the user terminal, based on the status information.

The information processing device according to the first aspect receives authentication request information requesting an authentication operation when an authentication operation is performed between a moving body for making deliveries, which is capable of autonomous movement, and a user terminal that communicates with the moving body. The information processing device acquires status information relating to a delivery status of the moving body, and transmits operation information relating to the authentication operation to the user terminal based on the acquired status information. This enables a user using the moving body to acquire, via the user terminal, information on an appropriate authentication operation corresponding to the delivery status, thereby enabling the authentication operation on the moving body to be facilitated.

Note that the term “authentication operation” as used herein is not limited to an operation performed directly on a moving body, but rather also broadly encompasses an operation performed via a communication means in order to authenticate a user terminal that communicates with the moving body.

An information processing device according to a second aspect is the configuration according to the first aspect, wherein: the status information includes position information relating to the user terminal and the moving body; and in a case in which a distance between the user terminal and the moving body is less than a predetermined threshold value, the transmitting section transmits the operation information to the user terminal.

In the information processing device according to the second aspect, in a case in which the distance between the user terminal and the moving body is less than a predetermined threshold value, operation information is transmitted to the user terminal. This enables the user to transmit operation information on the condition that the user has come within a predetermined distance of the moving body, thereby enabling the user to easily determine the moving body at which the authentication operation is to be performed.

An information processing device according to a third aspect is the configuration according to the first aspect or the second aspect, wherein the operation information includes an authentication code to be input into an authentication operation section provided at the moving body.

In the information processing device according to the third aspect, the operation information transmitted to the user terminal includes an authentication code to be input into the authentication operation section provided at the moving body. The user receives the authentication code via the user terminal, and inputs the received authentication code into the authentication operation section so as to be able to perform the authentication operation. Accordingly, the authentication operation performed on the moving body includes an operation performed directly on the moving body, thereby enabling the user to easily determine a case in which the moving body to be operated is incorrect. Note that “to be input into the authentication operation section” as used herein is not limited to input of character information or numerals, and also broadly encompasses input by reading an image.

An information processing device according to a fourth aspect is the configuration according to any one of the first aspect to the third aspect, wherein the information processing device further includes: an accepting section that accepts the authentication operation between the moving body and the user terminal; and a notification section that notifies a user of a corresponding operation section provided at the moving body, in response to the accepted authentication operation.

In the information processing device according to the fourth aspect, in a case in which an authentication operation between the moving body and the user terminal has been accepted, the information processing device notifies a user of a corresponding operation section provided at the moving body, in response to the authentication operation step. This enables the user to easily understand the operation section of the moving body corresponding to the authentication operation step.

A delivery system according to a fifth aspect includes: a moving body for making deliveries, which is capable of autonomous movement; a delivery management device that is configured to manage deliveries of the moving body; and the information processing device according to any one of the first aspect to the fourth aspect provided at the moving body or the delivery management device.

In the delivery system according to the fifth aspect, as described above, in a system that delivers packages via a moving body for making deliveries, authentication operation on the moving body can be facilitated.

An information processing method according to a sixth aspect includes: receiving authentication request information requesting an authentication operation between a moving body for making deliveries, which is capable of autonomous movement, and a user terminal that communicates with the moving body; acquiring status information relating to a delivery status of the moving body; and transmitting operation information relating to the authentication operation to the user terminal, based on the status information.

As described above, the information processing method according to the sixth aspect enables the authentication operation on the moving body to be facilitated in a case in which a package is delivered via the moving body for making deliveries.

A program according to a seventh aspect causes a computer to: receive authentication request information requesting an authentication operation between a moving body for making deliveries, which is capable of autonomous movement, and a user terminal that communicates with the moving body; acquire status information relating to a delivery status of the moving body; and transmit operation information relating to the authentication operation to the user terminal, based on the status information.

As described above, the program according to the seventh aspect enables the authentication operation on the moving body to be facilitated in a case in which a package is delivered via the moving body for making deliveries.

As described above, the information processing device, the delivery system, the information processing method, and the program according to the present disclosure enable authentication operation on a moving body to be facilitated in a case in which package delivery is performed via a moving body for making deliveries.

### BRIEF DESCRIPTION OF THE DRAWINGS

Exemplary embodiments of the present invention will be described in detail based on the following figures, wherein:

FIG. 1 is a schematic diagram illustrating a delivery system including a moving body according to an exemplary embodiment;

FIG. 2 is a schematic side view of a moving body according to an exemplary embodiment;

FIG. 3 is a block diagram illustrating a hardware configuration of an information processing device included in a delivery management device according to an exemplary embodiment;

FIG. 4 is a block diagram illustrating a functional configuration of an information processing device included in a delivery management device according to an exemplary embodiment;

FIG. 5 is a block diagram illustrating a hardware configuration of an information processing device included in a moving body according to an exemplary embodiment;

FIG. 6 is a block diagram illustrating a functional configuration of an information processing device included in a moving body according to an exemplary embodiment;

FIG. 7 is a sequence diagram illustrating an example of a flow of delivery processing according to an exemplary embodiment;

FIG. 8 is a flowchart illustrating an example of authentication processing according to an exemplary embodiment;

FIG. 9 is a flowchart illustrating an example of notification processing according to an exemplary embodiment; and

FIG. 10 is a block diagram illustrating a functional configuration of a modified example of an information processing device included in a delivery management device or a moving body.

### DETAILED DESCRIPTION

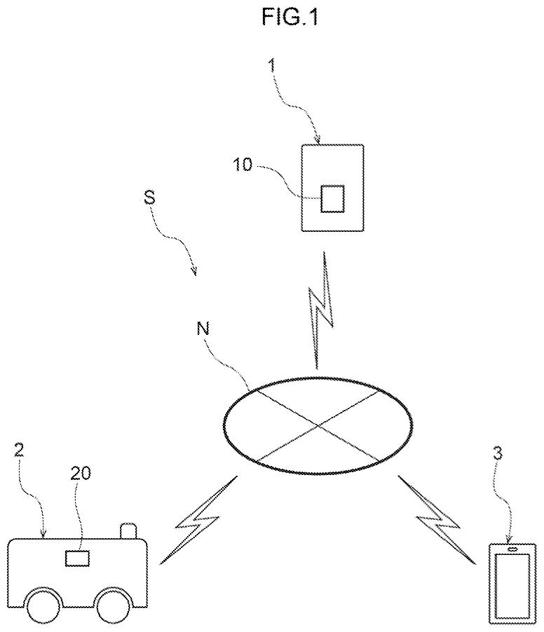

Explanation follows regarding a delivery system S according to an exemplary embodiment of the present disclosure, with reference to FIG. 1 to FIG. 9. As illustrated in FIG. 1, the delivery system S includes a delivery management device 1 that manages delivery, a moving body 2 for making deliveries, and a user terminal 3 that communicates with the moving body 2.

In the delivery system S, an information processing device 10 included in the delivery management device 1, an information processing device 20 included in the moving body 2, and the user terminal 3 are configured so as to be capable of communicating with each other via a network N. Further, information including information relating to a delivery requester, information relating to a delivery destination, information relating to a route to a delivery destination, and the like is stored in the information processing device 10 included in the delivery management device 1. The user terminal 3 is preferably a small terminal that can be carried by a user, and is configured by a terminal such as a smartphone or a tablet.

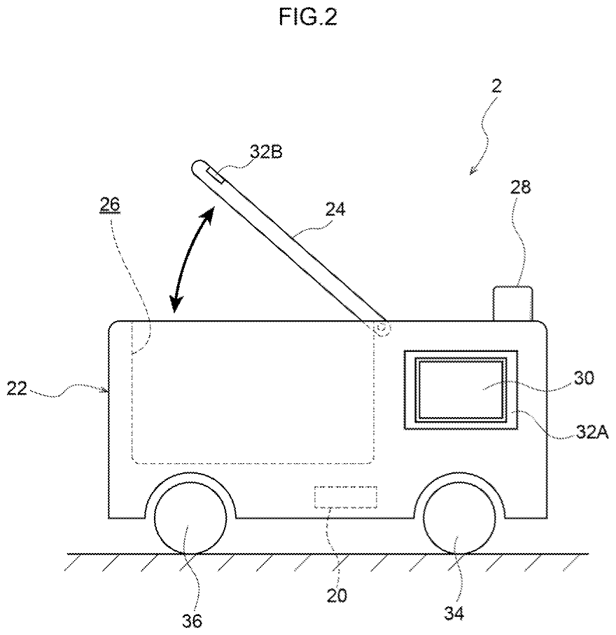

As illustrated in FIG. 2, as an example, the moving body 2 is configured by a vehicle that is capable of autonomous movement (autonomous travel). The moving body 2 includes a main body portion 22 including a movement mechanism, and an information processing device 20 provided at the main body portion 22.

The main body portion 22 is, as an example, a box shape having a rectangular parallelepiped shape, and is formed in a substantially rectangular shape in side view. A door-shaped opening and closing operation section 24 is provided at an upper portion of the main body portion 22. Further, a package compartment 26 configured to be openable and closable by the opening and closing operation section 24 is provided inside the main body portion 22. In addition, at the upper portion of the main body portion 22, a peripheral information detection sensor 28 is provided forward of the opening and closing operation section 24. The peripheral information detection sensor 28 is a sensor that detects obstacles and the like around the moving body 2 by combining an optical camera, radar, a LIDAR (Light Detection and Ranging) sensor, and the like.

An authentication operation section 30 is provided at a side surface of the main body portion 22. As an example, the authentication operation section 30 may be configured by a button type operation section, a touch panel, a two-dimensional code reading section for reading a QR code (registered trademark), a bar code or the like, and can input an authentication code received by the user terminal 3.

In the vicinity of the opening and closing operation section 24 and the authentication operation section 30 provided at the main body portion 22, operation section indicator lights 32A, 32B are provided to indicate the positions of the respective operation sections 24, 30 to a user using the moving body 2. The operation section indicator light 32A or 32B is illuminated so as to sequentially indicate the operation section 24 or 30 of the moving body 2 corresponding to the respective operation step when a package is delivered and received according to a prescribed procedure.

The main body portion 22 includes a left and right pair of front wheels 34 and a left and right pair of rear wheels 36 for enabling autonomous movement. Note that in FIG. 2, only the right side front wheel 34 and the right side rear wheel 36 are illustrated. The front wheels 34 and the rear wheels 36 are provided with a motor (not shown), and the front wheels 34 and the rear wheels 36 are configured to be rotated by driving force of the motor. Namely, the moving body 2 of the present exemplary embodiment is configured by an in-wheel motor.

Further, a battery (not shown) is provided inside the main body portion 22, and each of the front wheels 34 and the rear wheels 36 is independently driven by supplying power stored in the battery to the motor. Namely, the moving body 2 of the present exemplary embodiment is a type of battery electric vehicle (BEV).

(Hardware Configuration of the Information Processing Device 10 Included in the Delivery Management Device 1)

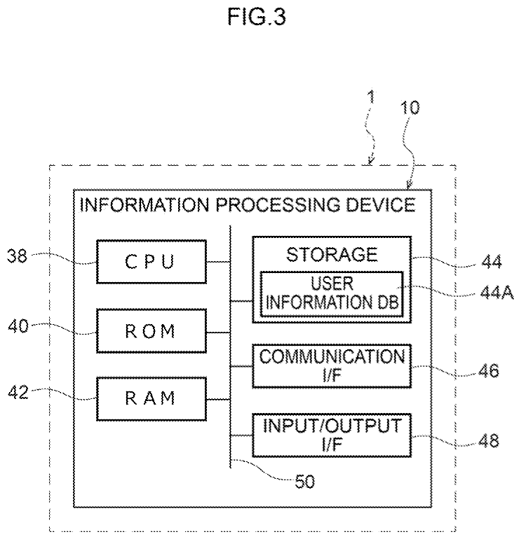

FIG. 3 illustrates a hardware configuration of the information processing device 10 included in the delivery management device 1. The information processing device 10 includes a central processing unit (CPU; serving as a processor) 38, read only memory (ROM) 40, random access memory (RAM) 42, storage 44, a communication interface (I/F) 46, and an input/output interface (I/F) 48. These respective configurations are communicably connected to each other via an internal bus 50. Note that the CPU 38 is an example of a processor, and the RAM 42 is an example of memory coupled to the processor.

The CPU 38 is a central processing unit that executes various programs and controls various components. Namely, the CPU 38 reads a program from the ROM 40 or the storage 44, and executes the program using the RAM 42 as a workspace. The CPU 38 controls the respective configurations described above and performs a variety of computation processing in accordance with the programs stored in the ROM 40 or the storage 44.

The ROM 40 stores various programs and various data. The RAM 42 serves as a workspace that temporarily stores programs and data. The storage 44 is configured by a hard disk drive (HDD) or a solid state drive (SSD), and stores various programs including an operating system, as well as various data. Moreover, the storage 44 stores a user information database 44A that stores registration information relating to a user of a delivery source requesting delivery of a package to the moving body 2, and relating to a user of a delivery destination receiving the package.

The communication I/F 46 serves as a communication section, and is an interface for the information processing device 10 to communicate with other devices and, for example, a protocol such as a controller area network (CAN), Ethernet (registered trademark), long term evolution (LTE), a fiber distributed data interface (FDDI), Wi-Fi (registered trademark), or Bluetooth (registered trademark) is used.

The input/output I/F 48 is an interface for connecting external devices to the information processing device 10, and is capable of connecting to an input device such as a keyboard or a display device such as a monitor.

(Functional Configuration of the Information Processing Device 10)

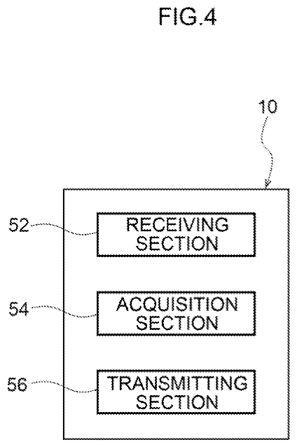

The information processing device 10 implements various functions using the above-described hardware resources. Explanation follows regarding functional configurations implemented by the information processing device 10, with reference to FIG. 4.

As illustrated in FIG. 4, the functional configuration of the information processing device 10 includes a receiving section 52, an acquisition section 54, and a transmitting section 56. The respective functional configurations are implemented by the CPU 38 reading and executing programs stored in the ROM 40 or the storage 44.

The receiving section 52 receives authentication request information requesting an authentication operation between the moving body 2 and the user terminal 3. In the present exemplary embodiment, since the authentication request information is transmitted from the user terminal 3, the authentication request information transmitted from the user terminal 3 is received by the receiving section 52 via the communication I/F 46.

Note that the receiving section 52 may receive the authentication request information transmitted from the moving body 2 by direct operation of the moving body 2.

The acquisition section 54 acquires status information relating to the delivery status of the moving body 2. The status information includes various status information acquired through intercommunication between the information processing device 10 and the moving body 2, and includes information such as whether or not a package to be delivered can be picked up, whether or not a package is traveling to a delivery destination, or of a standby state awaiting pick-up of a package at a delivery destination, for example.

In particular, in the present exemplary embodiment, position information relating to the moving body 2 and position information relating to the user terminal 3 are included in the status information. More specifically, when the authentication request information is transmitted from the user terminal 3, at the same time as this, the position information relating to the user terminal 3 is transmitted from the user terminal 3 to the information processing device 10. The acquisition section 54 identifies the moving body 2 corresponding to the received authentication request information, and acquires position information from the identified moving body 2. Note that the position information relating to the moving body 2 and the user terminal 3 is acquired using the functionality of GPS devices respectively installed at the moving body 2 and the user terminal 3, and is transmitted to the information processing device 10.

The transmitting section 56 transmits operation information relating to an authentication operation between the moving body 2 and the user terminal 3 to the user terminal 3 that transmitted the authentication request information. The transmitted operation information is determined based on the delivery status of the moving body 2 attempting authentication at the user terminal 3. For example, in a case in which the moving body 2 waiting for pick-up of a package at a delivery destination is requested to perform an authentication operation for pick-up of the package, operation information corresponding to the authentication operation at the time of pick-up is transmitted to the user terminal 3.

Moreover, in the present exemplary embodiment, regarding whether or not to transmit operation information, consideration is given to a distance L between the moving body 2 and the user terminal 3. More specifically, in a case in which the distance L between the moving body 2 and the user terminal 3 is less than a distance L1, the transmitting section 56 transmits operation information to the user terminal 3. Namely, the transmitting section 56 transmits operation information on the condition that a user (user terminal 3) has come within a predetermined distance of the moving body 2. This enables the user side to confirm whether or not the operation information has been received by the user terminal 3, and to understand that the user is approaching the moving body 2 at which the authentication operation is to be performed.

Moreover, in a case in which the distance L between the moving body 2 and the user terminal 3 is equal to or greater than the distance L1, the transmitting section 56 transmits the position information relating to the moving body 2 to the user terminal 3. This enables the user terminal 3 to indicate the position of the moving body 2 at a point on a map based on, for example, functionality of application software executed by the user terminal 3. As a result, the position of the moving body 2 can be understood from the user terminal 3.

(Hardware Configuration of the Information Processing Device 20 Included in the Moving Body 2)

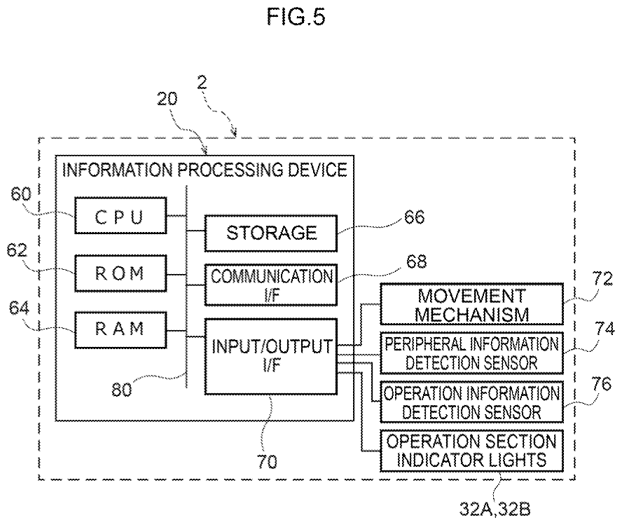

Next, explanation is provided regarding a hardware configuration of the information processing device 20 included in the moving body 2 with reference to FIG. 5. The information processing device 20 includes a central processing unit (CPU; serving as a processor) 60, read only memory (ROM) 62, random access memory (RAM) 64, storage 66, a communication interface (I/F) 68, and an input/output interface (I/F) 70. These respective configurations are communicably connected to each other via an internal bus 80. Note that the CPU 60 is an example of a processor, and the RAM 64 is an example of memory coupled to the processor.

The CPU 60 is a central processing unit that executes various programs and controls various components. Namely, the CPU 60 reads a program from the ROM 62 or the storage 66, and executes the program using the RAM 64 as a workspace. The CPU 60 controls the respective configurations described above and performs a variety of computation processing in accordance with programs stored in the ROM 63 or the storage 66.

The ROM 62 stores various programs and various data. The RAM 64 serves as a workspace that temporarily stores programs and data. The storage 66 is configured by an HDD or an SSD, and stores various programs including an operating system, as well as various data.

The communication interface I/F 68 serves as a communication section, and is an interface for the information processing device 20 to communicate with other devices and, for example, a protocol such as a CAN, Ethernet (registered trademark), LTE, FDDI, Wi-Fi (registered trademark), or Bluetooth (registered trademark) is used.

The input/output I/F 70 is an interface for connecting external devices to the information processing device 20, and a movement mechanism 72, a peripheral information detection sensor 74, an operation information detection sensor 76, and operation section indicator lights 32A, 32B are electrically connected to the input/output I/F 70.

The movement mechanism 72 is a mechanism for autonomously moving the moving body 2, and includes a pair of front wheels 34, a pair of rear wheels 36, and a motor (not shown) that transmits driving force to the front wheels 34 and the rear wheels 36.

As an example, the operation information detection sensor 76 is configured by combining a pressure sensor, an electrostatic sensor, or the like, and detects that predetermined operations have been performed on the opening and closing operation section 24, the authentication operation section 30, and the package compartment 26.

(Functional Configuration of the Information Processing Device 20)

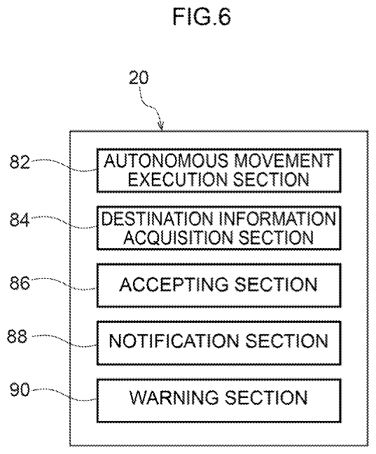

The information processing device 20 implements various functions using the above-described hardware resources. Explanation follows regarding functional configurations implemented by the information processing device 20, with reference to FIG. 6.

As illustrated in FIG. 6, the functional configuration of the information processing device 20 includes an autonomous movement execution section 82, a destination information acquisition section 84, an accepting section 86, a notification section 88, and a warning section 90. The respective functional configurations are implemented by the CPU 60 reading and executing programs stored in the ROM 62 or the storage 66.

The autonomous movement execution section 82 performs autonomous travel of the moving body 2. More specifically, the autonomous travel execution section 82 generates a travel plan based on peripheral information detected by the peripheral information detection sensor 74 and map information acquired from the delivery management device 1, and performs autonomous travel by controlling the movement mechanism 72 so as to move the moving body 2 based on the generated travel plan. Note that a high-precision map may be stored in advance in the storage 66 of the information processing device 20, and a travel plan may be generated based on the high-precision map.

The destination information acquisition section 84 acquires information such as an address of a destination. More specifically, when the delivery management device 1 of the moving body 2 accepts a package delivery request or a package collection request, a delivery instruction or a collection instruction is transmitted from the delivery management device 1 to the moving body 2. At this time, information such as the address of a delivery destination or a collection destination is transmitted from the delivery management device 1 to the moving body 2. The destination information acquisition section 84 acquires information such as the address of a delivery destination or a collection destination by receiving the same from the delivery management device 1.

In a case in which information such as the address of a destination is stored in the user information database 44A of the information processing device 10, the destination information acquisition section 84 may periodically access the user information database 44A to acquire information such as the address of a destination.

The accepting section 86 accepts an authentication operation between the moving body 2 and the user terminal 3. More specifically, in response to the authentication request information transmitted from the user terminal 3, the information processing device 10 transmits an authentication code for authentication operation to the user terminal 3. The authentication operation is accepted by the accepting section 86 by inputting the authentication code into the authentication operation section 30 of the moving body 2.

Note that in a case in which an authentication operation is performed by intercommunication between the information processing device 10 of the delivery management device 1 and the user terminal 3, the information processing device 10 accepts the authentication code input into the user terminal 3, thereby accepting the authentication information. The accepting section 86 may determine that an authentication operation has been accepted by notifying the completion of acceptance of authentication information from the information processing device 10 to the moving body 2.

The notification section 88 notifies the user of the corresponding operation section 24 or 30 provided at the moving body 2 in response to the step of the accepted authentication operation. More specifically, since an authentication operation on the moving body 2 is performed by operating the moving body 2 in a predetermined sequence, the operation section 24 or 30 corresponding to the respective step determined in the predetermined sequence is notified to the user by illuminating the operation section indicator light 32A or 32B. For example, in a case of receiving a delivered package, the user inputs an authentication code into the authentication operation section 30 of the moving body 2, and when authentication using the authentication code is completed, the opening and closing operation section 24 can be opened to take out the package. Accordingly, the notification section 88 illuminates the operation section indicator lamp 32A indicating the authentication operation section 30 of the moving body 2 at the step of input operation of the authentication code, and illuminates the operation section indicator lamp 32B indicating the opening and closing operation section 24 at the step of opening operation of the opening and closing operation section 24.

Although in the present exemplary embodiment, as an example, the operation section indicator lights 32A, 32B configure a notification device provided at the movable body 2, there is no limitation thereto. For example, a display or a speaker provided at the moving body 2 may be configured as a notification device, and the operation section that the user is to operate may be notified using character information, illustration, or voice information.

Further, in a case in which the operation section is notified by intercommunication between the information processing device 10 of the delivery management device 1 and the user terminal 3, the operation section that the user is to operate may be notified using character information, illustration, or voice information via a display section or a speaker of the user terminal 3.

The warning section 90 provides notification of warning information in a case in which, in an authentication operation in which a procedure has been defined, an operation has been performed on the operation section corresponding to the step of another operation before the step of the immediately preceding operation has been completed. In the present exemplary embodiment, as an example, warning information is notified to the information processing device 10 and the user terminal 3 by intercommunication via the communication interface 68. At this time, the operation section indicator light may be illuminated in a warning color such as red to warn the user who has operated the moving body 2.

(Operation)

Next, explanation is provided regarding the operation of the present exemplary embodiment.

(Delivery Processing)

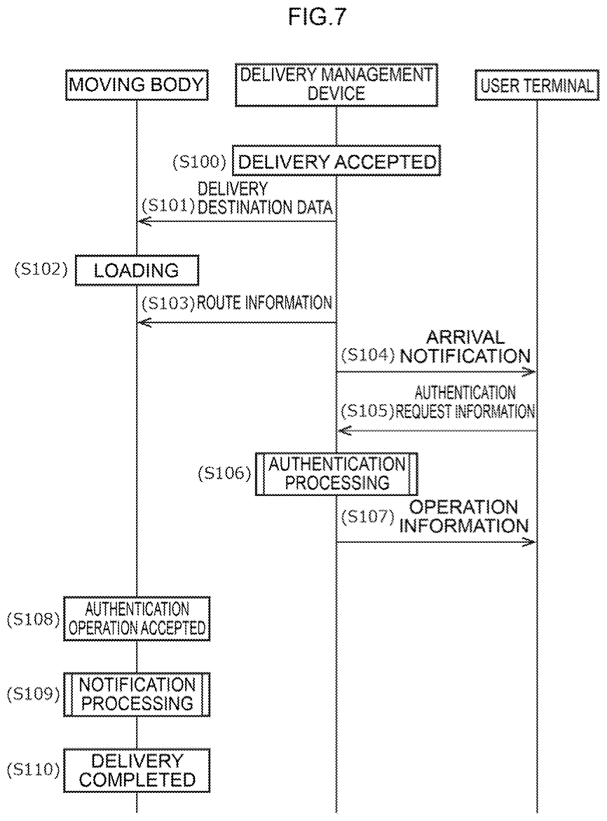

FIG. 7 is a sequence diagram illustrating an example of a flow of delivery processing in the present exemplary embodiment. In particular, detailed explanation follows regarding processing performed by the delivery management device 1, the moving body 2, and the user terminal 3 at the time of receiving delivered packages.

At step S100, an authentication operation with the moving body 2 is performed by a user terminal (not shown) on the user side requesting delivery of a package, and the completion of the authentication operation is notified to the delivery management device 1, and delivery is thereby accepted. The delivery management device 1 then transmits delivery destination data to the moving body 2.

At step S101, the moving body 2 acquires delivery destination data from the delivery management device 1.

At step S102, the package to be delivered is loaded into the package compartment 26 of the moving body 2.

At step S103, the moving body 2 acquires route information from the delivery management device 1. Note that the moving body 2 may acquire map information from the delivery management device 1 and calculate a route from the map information based on the delivery destination data.

Step S104 is processing after the moving body 2 has autonomously moved to a predetermined delivery destination. The delivery management device 1 acquires position information relating to the moving body 2, determines whether or not the moving body 2 has arrived at the delivery destination, and determines that it has arrived. In a case in which it is determined that the moving body 2 has arrived at the delivery destination, an arrival notification is transmitted from the delivery management device 1 to the user terminal 3 of the user who is to receive the package. Note that the delivery management device 1 may determine that the moving body 2 has arrived at the delivery destination by receiving the arrival notification transmitted from the moving body 2. Moreover, there is no limitation thereto, and the delivery management device 1 may transmit an arrival notification to the user terminal 3 in a case in which the distance or time from the moving body 2 to the delivery destination is less than a predetermined threshold.

Step S105 is processing performed when a user goes to receive a package, and the delivery management device 1 receives authentication request information from the user terminal 3 using the functionality of the receiving section 52.

At step S106, authentication processing is performed using the functionality of the transmitting section 56 of the delivery management device 1. The flow of the authentication processing will be described below.

At step S107, the delivery management device 1 uses the functionality of the transmitting section 56 to transmit operation information relating to an authentication operation between the moving body 2 and the user terminal 3 to the user terminal 3. More specifically, the delivery management device 1 transmits an authentication code to the user terminal 3 in order to input into the authentication operation section 30 provided in the moving body 2.

At step S108, the authentication operation is accepted using the functionality of the accepting section 86 of the moving body 2. More specifically, the authentication operation is accepted by inputting an authentication code into the authentication operation section 30 of the moving body 2.

At step S109, notification processing is performed using the functionality of the notification section 88 of the moving body 2. The flow of the authentication processing will be described below.

At step S110, based on the operation information detection sensor 76 provided at the moving body 2, delivery is completed by the removal of the package from the package compartment 26 being detected.

(Authentication Processing)

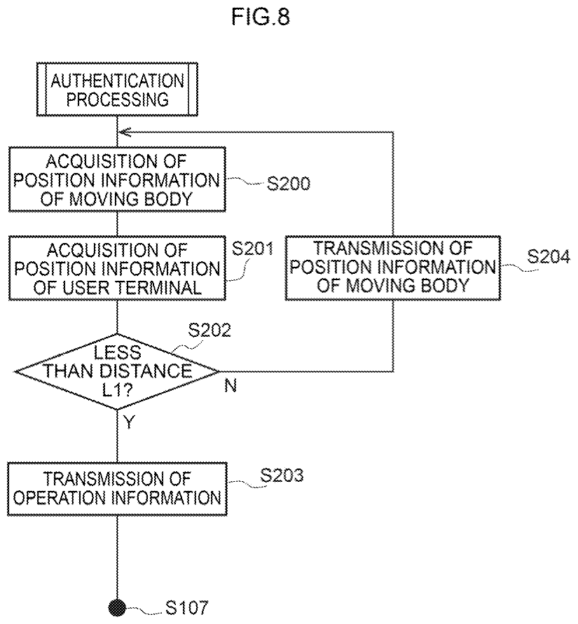

Explanation follows regarding authentication processing performed by the delivery management device 1, with reference to the flowchart illustrated in FIG. 8. In this authentication processing, it is determined whether or not to transmit operation information, based on the position information relating to the moving body 2 and the position information relating to the user terminal 3.

At step S200, the CPU 38 of the delivery management device 1 (information processing device 10) acquires position information relating to the moving body 2 using the functionality of the acquisition section 54.

At step S201, the CPU 38 uses the functionality of the acquisition section 54 to acquire position information relating to the user terminal 3 on the user side that receives the package.

At step S202, the CPU 38 uses the functionality of the transmitting section 56 to determine whether or not the distance L between the moving body 2 and the user terminal 3 is less than the distance L1. In a case in which the CPU 38 determines that the distance L is less than the distance L1, the processing transitions to step S203. On the other hand, in a case in which the CPU 38 determines that the distance L is equal to or greater than the distance L1, the processing transitions to step S204.

At step S203, the CPU 38 uses the functionality of the transmitting section 56 to transmit operation information to the user terminal 3. This enables the operation information to be transmitted on the condition that the user who is to receive the package has come within a predetermined distance of the moving body 2. When the processing of step S203 has ended, the CPU 38 ends the authentication processing, and processing transitions to the processing of step S107 of the delivery processing.

At step S204, the CPU 38 uses the functionality of the transmitting section 56 to transmit position information relating to the moving body 2 to the user terminal 3. This enables the user who is to receive the package to understand the position of the moving body 2 from the user terminal 3. When the processing of step S204 has ended, the CPU 38 returns to step S200 and repeats the processing.

(Notification Processing)

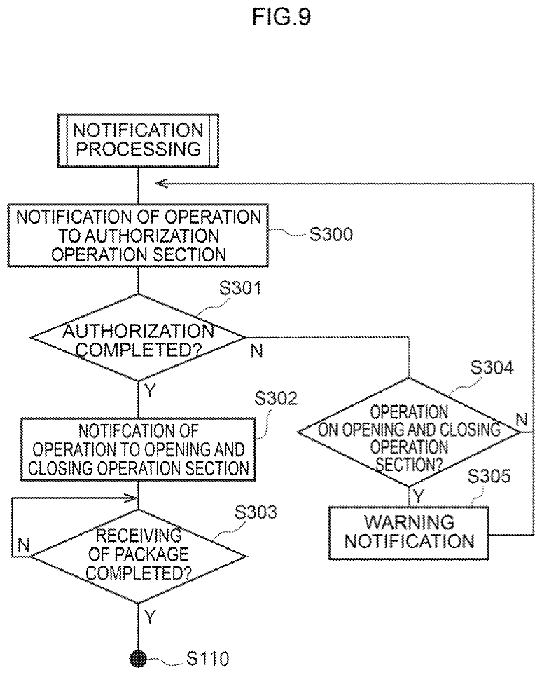

Next, explanation is provided regarding notification processing performed by the moving body 2, with reference to the flowchart illustrated in FIG. 9. In the notification processing, during an authentication operation, the operation section 24 or 30 corresponding to the operation performed on the moving body 2 is notified to the user.

At step S300, the CPU 60 of the moving body 2 (information processing device 20) uses the functionality of the notification section 88 to illuminate the operation section indicator light 32A, thereby notifying the user that an operation is being performed on the authentication operation section 30.

At step S301, the CPU 60 determines whether or not authentication has been completed using the authentication code input into the authentication operation section 30. In a case in which the CPU 60 determines that the authentication has been completed, the processing transitions to step S302. On the other hand, in a case in which the CPU 60 determines that the authentication has not been completed, the processing transitions to step S304.

At step S302, the CPU 60 uses the functionality of the notification section 88 to illuminate the operation section indicator light 32B, thereby notifying the user that operation should be performed on the opening and closing operation section 24. In this manner, the operation section indicator lamp 32A and the operation section indicator lamp 32B are illuminated sequentially according to the operation procedure of the authentication operation, thereby enabling the operation section corresponding to the step of the operation to be notified to the user.

Thereafter, at step S303, the CPU 60 determines whether or not receiving of the package has been completed. More specifically, based on the detection result of the operation information detection sensor 76, in a case in which the CPU 60 determines that the package has been taken out of the package compartment 26 of the moving body 2, the CPU 60 determines that receiving of the package has been completed. In a case in which the CPU 60 determines that receiving of the package has been completed, the notification processing is ended, and processing transitions to step S110 of the delivery processing. Further, in a case in which the CPU 60 determines that receiving of the package has not been completed, the processing of step S303 is repeated.

On the other hand, in a case in which authentication using an authentication code has not been completed, at step S304, the CPU 60 determines whether or not the opening and closing operation section 24 corresponding to the next operation step has been operated. More specifically, the CPU 60 uses the functionality of the warning section 90 to determine whether or not an opening operation has been performed on the opening and closing operation section 24. In a case in which the CPU 60 determines that the opening and closing operation section 24 has been operated, the processing transitions to step S305. On the other hand, in a case in which the CPU 60 determines that the opening and closing operation section 24 has not been operated, the CPU 60 returns to step S300 and repeats the processing.

At step S305, the CPU 60 uses the functionality of the warning section 90 to notify warning information to the information processing device 10 and the user terminal 3. This enables an administrator of the information processing device 10 and a user who is to receive the package to know that the package compartment 26 of the moving body 2 is about to be opened by unreasonable means. This enables an administrator of the delivery system S or a user who is to receive a package to be warned in a case in which a suspicious person is attempting to forcibly take a package from the package compartment 26 of the moving body 2. When the processing of step S305 ends, the CPU 60 returns to step S300 and repeats the processing.

As described above, the information processing device 10 included in the delivery management device 1 receives authentication request information requesting an authentication operation when an authentication operation is performed between the moving body 2 for making deliveries, which is capable of autonomous movement, and the user terminal 3 that communicates with the moving body 2 for making deliveries. Status information relating to the delivery status of the moving body 2 is then acquired, and operation information for authentication operation based on the acquired status information is transmitted to the user terminal 3. This enables a user using the moving body 2 to acquire information on appropriate authentication operations corresponding to the delivery status via the user terminal 3, and the authentication operation on the moving body 2 can thereby be facilitated.

Further, in the information processing device 10, when a user uses the moving body 2, in a case in which the distance L between the user terminal 3 and the moving body 2 is less than the predetermined distance L1, operation information is transmitted to the user terminal 3. This enables operation information to be transmitted on the condition that the user has come within a predetermined distance of the moving body 2, thereby enabling the user to easily determine the moving body 2 at which an authentication operation is to be performed.

Moreover, in a case in which the distance L between the user terminal 3 and the moving body 2 is equal to or greater than the predetermined distance L1, the information processing device 10 transmits position information relating to the moving body 2 to the user terminal 3. This enables the position of the moving body 2 to be guided from the user terminal 3 in a case in which the authentication request information is received from the user terminal 3 located at a point away from the moving body 2, thereby enabling convenience to the user to be improved.

Further, in the present exemplary embodiment, the operation information transmitted to the user terminal 3 includes an authentication code that is input into the authentication operation section 30 provided at the moving body 2. The user receives the authentication code via the user terminal 3, and inputs the received authentication code into the authentication operation section 30 so as to be able to perform an authentication operation. Accordingly, the authentication operation performed on the moving body 2 includes an operation performed directly on the moving body 2, thereby enabling the user to easily determine a case in which the moving body 2 at which the operation to be performed is incorrect.

Moreover, in a case in which the information processing device 20 included in the moving body 2 accepts an authentication operation between the moving body 2 and the user terminal 3, in response to the step of the authentication operation, the corresponding operation section 24 or 30 provided at the moving body 2 is notified to the user. This enables the user to easily understand the operation section 24 or 30 of the moving body 2 that corresponds to the step of the authentication operation.

Further, the information processing device 20 notifies at least one of the information processing device 10 or the user terminal 3 of warning information in a case in which, in an authentication operation in which a procedure has been defined, an operation has been performed on the operation section 24 or 30 corresponding to the step of another operation before the step of the immediately preceding operation has been completed. More specifically, in the present exemplary embodiment, when an operation is performed on the opening and closing operation section 24 before authentication of the authentication code input into the authentication operation section 30 of the moving body 2 is completed, the warning information is notified. This enables an administrator of the information processing device 10 and the user who is to receive the package to be informed that the package compartment 26 of the moving body 2 is about to be opened by unreasonable means.

[Supplementary Explanation]

Although explanation has been given regarding the information processing devices 10, 20 and the moving body 2 which configure the delivery system S according to the exemplary embodiments, obviously various embodiments may be implemented within a range not departing from the gist of the present disclosure.

### Modified Example

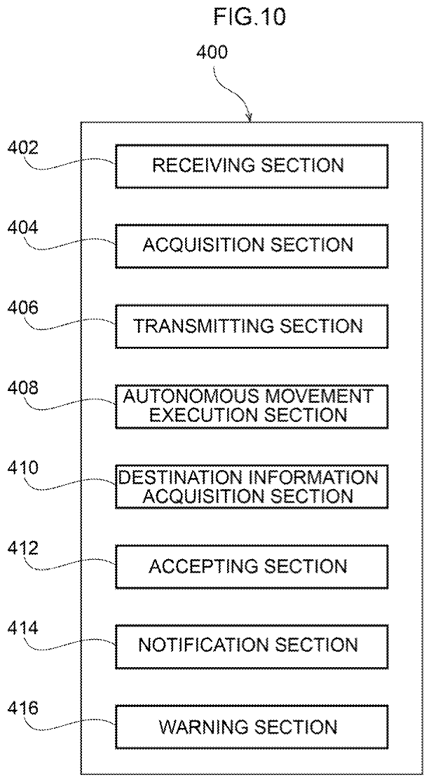

Although the authentication processing is executed by the information processing device 10 included in the delivery management device 1 and the notification processing is executed by the information processing device 20 included in the moving body 2 in the above exemplary embodiments, there is no limitation thereto. For example, as in the information processing device 400 according to the modified example illustrated in FIG. 10, the information processing device 400 may be configured to perform processing executed by the information processing device 10 and the information processing device 20 in the above exemplary embodiments. Explanation follows regarding the information processing device 400 according to a modified example, with reference to FIG. 10. Note that the same reference numerals are assigned to the same components as those in the above exemplary embodiments, and explanation thereof is omitted.

The information processing device 400 can be provided at the delivery management device 1 or the moving body 2. Since the hardware configuration of the information processing device 400 is similar to the configuration of the information processing device 10 in the above exemplary embodiments, explanation thereof is omitted.

FIG. 10 is a block diagram illustrating the functional configuration of the information processing device 400. The respective functions of the information processing device 400 are implemented by the CPU 38 reading and executing programs stored in the ROM 40. As illustrated in FIG. 10, the information processing device 400 includes a receiving section 402, an acquisition section 404, a transmitting section 406, an autonomous movement execution section 408, a destination information acquisition section 410, an accepting section 412, a notification section 414, and a warning section 416.

The receiving section 402, the acquisition section 404, the transmitting section 406, the autonomous movement execution section 408, the destination information acquisition section 410, the accepting section 412, the notification section 414, and the warning section 416 respectively correspond to the receiving section 52, the acquisition section 54, the transmitting section 56, the autonomous movement execution section 82, the destination information acquisition section 84, the accepting section 86, the notification section 88, and the warning section 90 in the above exemplary embodiments. Note that operation of the various sections of the information processing device 400 is similar to the operation of the information processing device 10 and the information processing device 20 described in the above exemplary embodiments, and therefore detailed explanation thereof is omitted.

Note that the following configuration of the moving body 2 is disclosed in the above exemplary embodiments.

A moving body for making deliveries that includes a main body portion including a movement mechanism and an information processing device provided at the main body portion, wherein the information processing device includes: an autonomous movement execution section configured to control the movement mechanism to enable the main body portion to autonomously move; a destination information acquisition section that acquires information relating to a delivery destination or a collection destination of a package; an accepting section that accepts an authentication operation between the moving body and a user terminal that communicates with the moving body; and a notification section that notifies a user of a corresponding operation section provided at the moving body in response to the accepted authentication operation step.

Although the authentication operation performed between the moving body 2 and the user terminal 3 has been described focusing on the authentication operation performed when a package is received from the moving body 2 in the above exemplary embodiments, the authentication operation performed between the moving body 2 and the user terminal 3 when a package is delivered is also included in the authentication operation performed between the moving body 2 and the user terminal 3. Namely, the authentication processing illustrated in FIG. 8 and the notification processing illustrated in FIG. 9 may be executed by receiving authentication request information from the user terminal 3 of a user wishing to request delivery of a package.

Further, although explanation has been given regarding a moving body configured by a vehicle that is capable of autonomous travel in the above exemplary embodiments, there is no limitation thereto, and a moving body may be configured by a flying body that is capable of autonomous travel, a ship that is capable of autonomous travel, or the like, such as a drone.

Note that in the above-described embodiments, any of various types of processors other than a CPU may execute the various processing that the CPUs 38, 60 execute by reading software (programs). Examples of such processors include a Programmable Logic Device (PLD) in which the circuit configuration can be modified post-manufacture, such as a Field-Programmable Gate Array (FPGA), or a specialized electric circuit that is a processor with a specifically-designed circuit configuration for executing specific processing, such as an Application Specific Integrated Circuit (ASIC). Further, each processing of delivery processing, authentication processing, and notification processing may be executed by one of these various types of processors, or may be executed by combining two or more of the same type or different types of processors (e.g., plural FPGAs, or a combination of a CPU and an FPGA, or the like). Further, a hardware configuration of the various processors is specifically formed as an electric circuit combining circuit elements such as semiconductor elements.

Moreover, although explanation has been given regarding an aspect in which a program for authentication processing and notification processing is pre-stored (pre-installed) in ROM or storage in the above exemplary embodiments, there is no limitation thereto. The programs may be provided in a format recorded on a storage medium such as Compact Disc Read Only Memory (CD-ROM), Digital Versatile Disc Read Only Memory (DVD-ROM), or Universal Serial Bus (USB) memory. Alternatively, the programs may be provided in a format downloadable from an external device over a network.

The flow of processing described in the above exemplary embodiments is merely an example thereof, and unnecessary steps may be omitted, new steps may be added, or the processing sequence may be rearranged within a range not departing from the gist thereof.

1. An information processing device comprising:
at least one processor, wherein the at least one processor is configured to:
receive authentication request information requesting an authentication operation between a moving body for making deliveries, which is capable of autonomous movement, and a user terminal that communicates with the moving body;
acquire status information relating to a delivery status of the moving body; and
transmit operation information relating to the authentication operation to the user terminal, based on the status information.

2. The information processing device according to claim 1, wherein:
the status information includes position information relating to the user terminal and the moving body; and
in a case in which a distance between the user terminal and the moving body is less than a predetermined threshold value, the processor is configured to transmit the operation information to the user terminal.

3. The information processing device according to claim 1, wherein the operation information includes an authentication code to be input into an authentication operation section provided at the moving body.

4. The information processing device according to claim 1, wherein the processor is configured to:
accept the authentication operation between the moving body and the user terminal; and
notify a user of a corresponding operation section provided at the moving body, in response to the accepted authentication operation.

5. A delivery system comprising:
a moving body for making deliveries, which is capable of autonomous movement;
a delivery management device that is configured to manage deliveries of the moving body; and
the information processing device according to claim 1 provided at the moving body or the delivery management device.

6. An information processing method comprising executing processing by a computer, the processing comprising:
receiving authentication request information requesting an authentication operation between a moving body for making deliveries, which is capable of autonomous movement, and a user terminal that communicates with the moving body;
acquiring status information relating to a delivery status of the moving body; and
transmitting operation information relating to the authentication operation to the user terminal, based on the status information.

7. A non-transitory computer-readable storage medium storing a program that is executable by a computer to perform processing, the processing comprising:
receiving authentication request information requesting an authentication operation between a moving body for making deliveries, which is capable of autonomous movement, and a user terminal that communicates with the moving body;
acquiring status information relating to a delivery status of the moving body; and
transmitting operation information relating to the authentication operation to the user terminal, based on the status information.
